(19) United States
(12) Patent Application Publication
(10) Pub. No.: US 2008/0200321 A1
(43) Pub. Date: Aug. 21, 2008

(54) DISPENSING CONTAINER HAVING COMPLIANCE FEATURES

(75) Inventors: Michael J. Bittner, Charlotte, NC (US); Wade H. Bryant, Charlotte, NC (US); Mark A. Duke, Charlotte, NC (US)

Correspondence Address: SUMMA, ALLAN & ADDITON, P.A., 11610 NORTH COMMUNITY HOUSE ROAD, SUITE 200, CHARLOTTE, NC, 28277, US

(73) Assignee: CADMUS, Charlotte, NC (US)

(21) Appl. No.: 12/031,986

(22) Filed: Feb. 15, 2008

Related U.S. Application Data
(60) Provisional application No. 60/890,259, filed on Feb. 16, 2007.

(51) Int. Cl. B65D 17/28; B65D 73/00; B31B 1/88; B31B 1/00

(52) U.S. Cl. 493/53; 206/461; 229/220; 493/84

(57) ABSTRACT

The invention relates to a dispensing container having compliance features in which the container has a bottom panel that defines at least one opening, a top panel that is secured to the bottom panel, and a moveable security member positioned between the bottom and top panels. The top panel provides a perforated access tab that is releasably secured to the bottom panel to form a stop that prevents movement of the security member. The top panel may further provide a perforated cut-out that provides an opening in the top panel to permit the dispensing of articles within the container. The invention further relates to a method of manufacturing a packaging blank capable of forming a container having indicia and compliance features.

### CROSS-REFERENCE TO PRIORITY APPLICATIONS

This application hereby claims the benefit of commonly assigned U.S. provisional patent application Ser. No. 60/890,259 (filed Feb. 16, 2007, in the U.S. Patent and Trademark Office), and incorporates by reference the provisional patent application in its entirety.

### BACKGROUND OF THE INVENTION

This invention relates to a container for dispensing articles with features which promote compliance with established guidelines for dispensing particular articles. More specifically, the invention is a container for sequentially dispensing articles in accordance with compliance requirements. In one embodiment, the invention is a unit dose package for containing pharmaceuticals which promotes patient compliance with recommended dosage. The dispensing container further promotes safety with respect to child resistant packaging and ease of use with respect to senior patients.

A variety of pharmaceuticals are prescribed for consumption at a specified dosage per day. Compliance guidelines may require that a particular dosage of medication be consumed per day. For example, compliance guidelines may require that a patient consume medication over a one week period at increasing 10 milligram (mg) increments per day.

Known packaging incorporates written instructions describing the sequential dosage of medication (i.e., compliance guidelines). Other packaging may incorporate instructional tear strips describing compliance guidelines. This known packaging often fails to include clear dosage instructions, thereby increasing the likelihood of a patient ingesting an incorrect dosage which could lead to medical complications. Further, known packaging often fails to provide sufficient security features for child resistant packaging and fails to provide packaging readily opened by senior patients. Known dispensing containers are often too complicated to be readily accessed by seniors, or too flimsy to provide adequate child resistant features. Other known dispensing containers provide inadequate features for enforcing compliance with unit dosage requirements or, when provided, the features require time-consuming education provided by, for example, a pharmacist or doctor. The present invention provides a dispensing container having compliance and safety features which address these problems.

### SUMMARY OF THE INVENTION

The invention is a container for dispensing articles having a bottom panel that defines at least one opening, a top panel that is secured to the bottom panel, and a moveable security member positioned between the bottom and top panels. In one embodiment, the dispensing container may include at least one perforated access tab defined by the top panel. The perforated access tab may extend along a portion of the width of the bottom panel. The perforated access tab is releasably secured to a portion of the bottom panel with, for example, an adhesive placed on the bottom panel or perforated access tab. The adhesive is positioned substantially adjacent to a portion of the security member. The adhesive forms an attachment point between the perforated access tab and bottom panel. The attachment point defines a stop that prevents movement of a shaped security member within the container and prevents the dispensing of articles from the container. Upon release of the perforated access tab, the security member is moveable (i.e., indexed to another stop formed by another adjacent perforated access tab) and articles within the container are dispensed through an opening formed by, in one embodiment, the removal of a portion of the perforated access tab.

In another embodiment, the top panel includes a perforated cut-out positioned substantially adjacent to the perforated access tab. Upon removal of the perforated access tab from the bottom panel, the security member is moveable. In this embodiment, the articles are dispensed through an opening formed by removal of the perforated cut-out as compared to an opening formed by removal of the perforated access tab.

Stated differently, upon release from the top panel the perforated access tab permits the security member to advance within the interior of the container. Movement of the security member facilitates communication between the interior of the container and an opening formed in the top panel by the perforated access tab or the perforated cut-out. Thus, movement or indexing of the security member permits the passage of an article from the interior of the container through an opening in the top panel.

Advantageously, the dispensing container may include multiple openings in the bottom panel, and multiple perforated access tabs and multiple perforated cut-outs in the top panel. Accordingly, the sequential release of the access tabs from the top panel and the advancement or indexing of the security member adjacent the openings promotes the dispensing of, for example, pharmaceuticals, in accordance with compliance requirements.

Access slots are provided in the top panel to facilitate removal of the access tabs. The access slots are formed substantially adjacent to the perforated access tabs and permits a user to insert a finger into the slot and remove a portion of the access tab prior to dispensing.

The invention may further provide a blister card or blister pack secured between the bottom panel and security member, wherein the blister card defines at least one cavity that contains, for example, pharmaceuticals. As configured, the cavity is correspondingly aligned with an opening in the bottom panel such that the opening receives that portion of the blister card defined by the cavity and containing the pharmaceutical.

In one embodiment, the perforated cut-out is correspondingly aligned with the opening in the bottom panel and the cavity defined by the blister card. In this embodiment, the perforated cut-out provides an opening through which articles are dispensed. More specifically, a user may remove a portion of one or more perforated access tabs, advance the security member beyond one opening in the bottom panel, apply a force against the cavity, and dispense a dosage through an opening in the top panel formed by the perforated cut-out. In the embodiment lacking the perforated cut-out, the dosage is dispensed through an opening formed by removal of at least a portion of the perforated access tab.

The invention may also provide at least one cover panel that is flexibly connected to the bottom or top panel by at least one side panel. The cover panel is foldable over the bottom and top panel for shipment and storage. In this embodiment, the cover panel provides additional protection for the articles within the container and additional surface area for indicia such as trademarks, instructions, or the like. It will be understood that other embodiments of the invention may provide two cover panels connected to the bottom and top panels, respectively, opposite one another.

The bottom and top panels further define a tear flap at one end of the dispensing container. The tear flap is formed by perforations extending along free edges of the bottom and top panels. In use, removal of the tear flap permits access to an end of the security member such that a user may pull the security member to advance it within the container. A portion of the perforations defining the tear flap may extend inwardly from an edge of the bottom and top panels to form a recess or indent in the panels. The indent permits ready access to an end of the security member extending beyond the edge of the top and bottom panels upon removal of the tear flap.

The dispensing container can be formed from cardboard, rigid paper, flexible plastic, or similar material made of paperboard or plastic, or any other material suitable for the purposes of the invention as set forth herein.

Thus, the invention provides, among other benefits, a container that facilitates the sequential dispensing of articles stored within the container in accordance with, for example, pharmaceutical compliance requirements. In particular, the combination of the moveable security member and perforated access tabs that provide sequential advancement of the security member promotes adherence to compliance requirements and ease of use lacking in known dispensing containers.

### BRIEF DESCRIPTION OF THE DRAWINGS

The foregoing and other objects and advantages of the invention and the manner in which the same are accomplished will become clearer based on the following detailed description taken in conjunction with the accompanying drawings in which:

FIG. 1 is a perspective view of one embodiment of the dispensing container of the invention;

FIG. 2 is a partial enlarged longitudinal cross-section view of one embodiment of the dispensing container taken generally along line 2-2 of FIG. 1 depicting the bottom panel, top panel, security member, and blister card containing articles;

FIG. 3 is a partial perspective view of one embodiment of the dispensing container illustrating removal of a tear flap from the dispensing container;

FIG. 4 is a partial enlarged longitudinal cross-section view of one embodiment of the dispensing container taken generally along line 4-4 of FIG. 3 showing one end of the container;

FIG. 5 is a perspective view of one embodiment of the dispensing container illustrating the release of a perforated access tab, advancement of the security member, and removal of an article from the blister card;

FIG. 6 is a partial enlarged longitudinal cross-section view of one embodiment of the dispensing container taken generally along line 6-6 of FIG. 5 depicting removal of an article from the blister card;

FIG. 7 is a top plan view of one embodiment of a top panel of the dispensing container;

FIG. 8 is a top plan view of one embodiment of a bottom panel of the dispensing container;

FIG. 9 is a perspective view of one embodiment of a security member of the dispensing container;

FIG. 10A is a perspective view of one embodiment of the bottom panel of the dispensing container depicting one embodiment of a blister card;

FIG. 10B is a perspective view of one embodiment of the bottom panel of the dispensing container depicting one embodiment of the blister card and security member;

FIG. 10C is a partial exploded view of one embodiment of the dispensing container;

FIG. 11 is an enlarged lateral cross-section view of one embodiment of the dispensing container taken generally along line 11-11 of FIG. 1;

FIG. 12 is an enlarged lateral cross-section view of one embodiment of the dispensing container taken generally along line 12-12 of FIG. 5 illustrating release of a perforated access tab from the bottom panel;

FIG. 13 is an enlarged perspective view of one embodiment of the dispensing container depicting one end of the container wherein the security member has been advanced past one opening in the top panel and an article has been dispensed;

FIG. 14 is a top plan view of another embodiment of the top panel of the dispensing container;

FIG. 15 is a top plan view of another embodiment of the bottom panel of the dispensing container; and

FIG. 16 is a schematic diagram of the method of manufacturing a packaging blank capable of forming a container having indicia and compliance features.

### DETAILED DESCRIPTION OF THE INVENTION

The invention will now be described more fully hereinafter with reference to the accompanying drawings, in which multiple embodiments of the invention are shown. This invention may, however, be embodied in different forms and should not be construed as limited to the embodiments set forth herein. Rather, these embodiments are provided so that this disclosure will be thorough and complete and will fully convey the scope of the invention to those skilled in the art. Like numbers refer to like elements throughout. Further, like numbers with the prime notation refer to like or similar elements of the structure.

As known to those skilled in the art, packaging is typically formed from packaging blanks, or blanks for short. It will be understood that as used herein the term “blank” may include cardboard, rigid paper, flexible plastic, or similar products made of paperboard or plastic. In particular, the packaging industry favors the use of one-piece flexible blanks, which are readily incorporated into automated processes for forming containers. It will be understood by those skilled in the art that the term “container” as used herein refer to various embodiments of the present structure for retaining a variety articles as formed from the various embodiments of the blank described below.

As used herein, the term “panel” is used in conjunction with the dispensing container of the present invention and refers to the major component part of a folding container and defines the major partition elements of the blank or container. It will be understood that panels include edges defined as the line of intersection of two surfaces or a border. A “free edge” of a panel refers to an edge that does not intersect with another surface or panel.

The term “flap” refers to a secondary container element that is typically hinge-connected along a free edge of a panel or another flap. It will be understood that the term “tab” refers to a tertiary element of the blank or container that is generally hinged to a portion of a free edge of a panel or flap, or struck from within the plane of a panel or flap.

It will be understood that the terms “top panel” and “lower panel” may also refer to “lower panel” and “upper panel” dependent upon the perspective of the individual viewing the apparatus. It will also be appreciated that the term “top” implies the opposite of “bottom.”

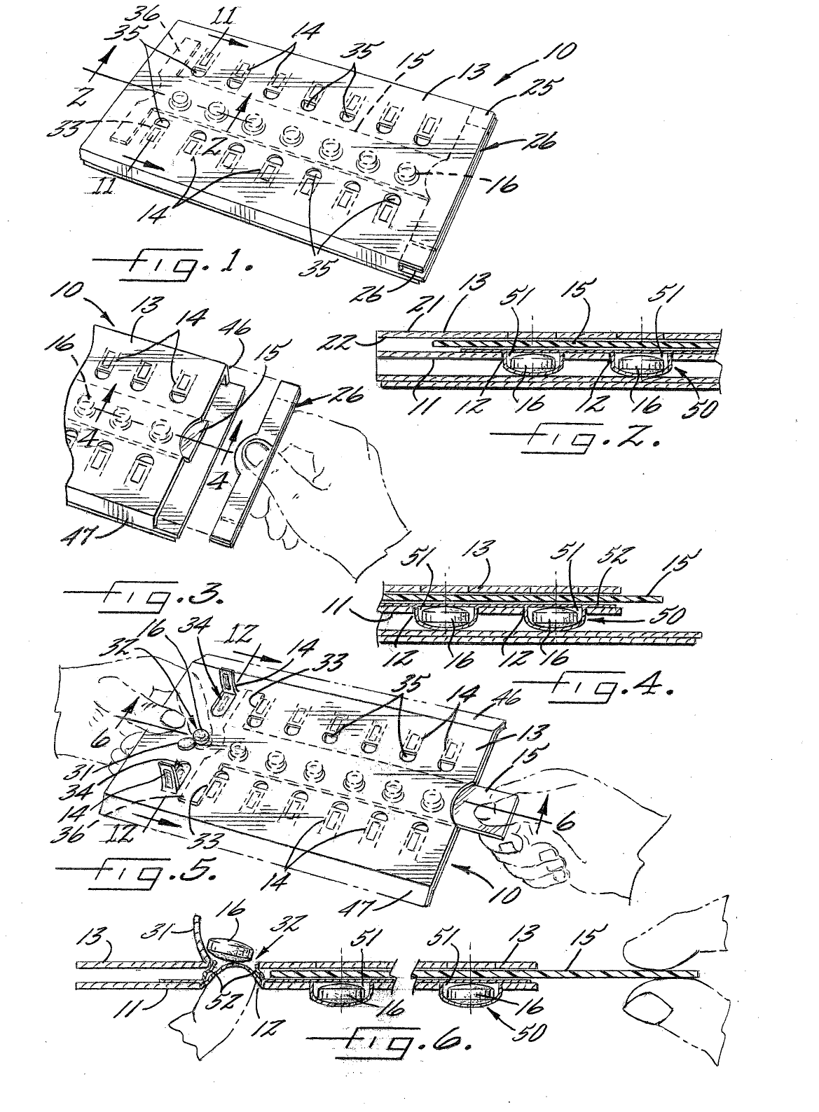

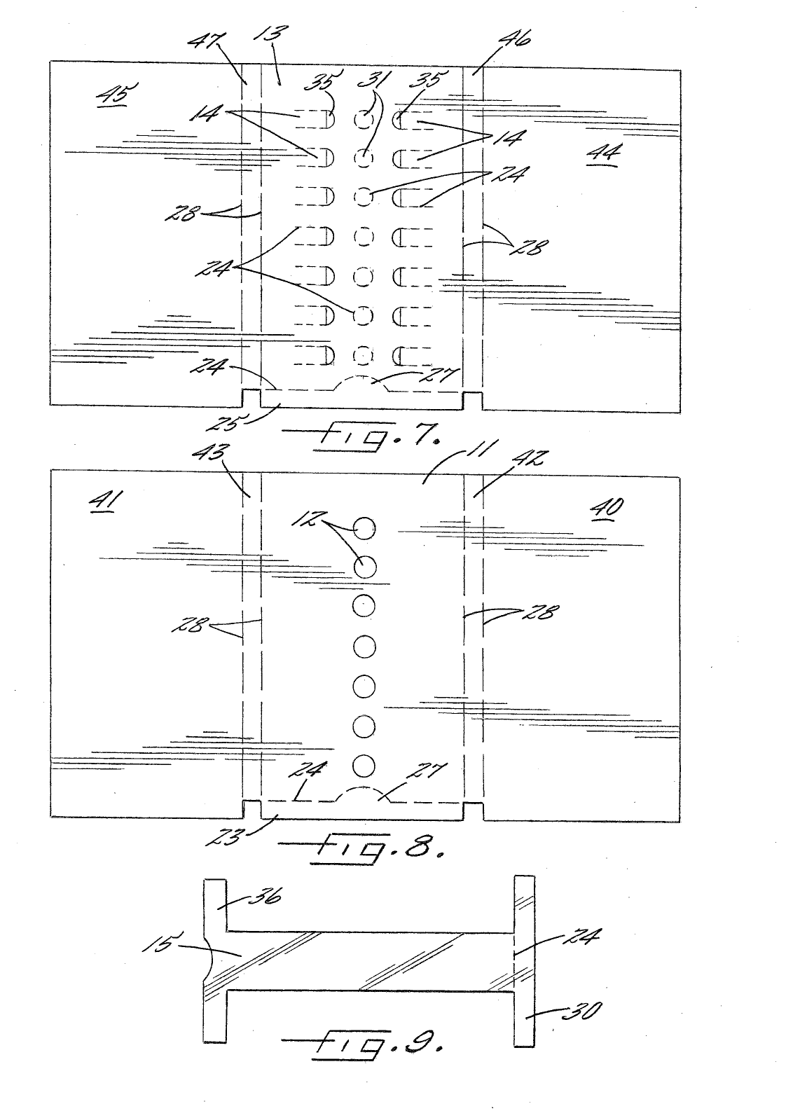

With reference to the orientation of the container in FIG. 1, it will be understood that the terms “internal surface” and “external surface” may be referred to as “inside surface” and “outside surface.” Stated differently, as used herein the term internal surface implies the surface of the container closest to the interior of the container. Thus, it will be understood that the term external surface implies the side of the container opposite the internal surface (i.e., the side farthest from the interior of the container).

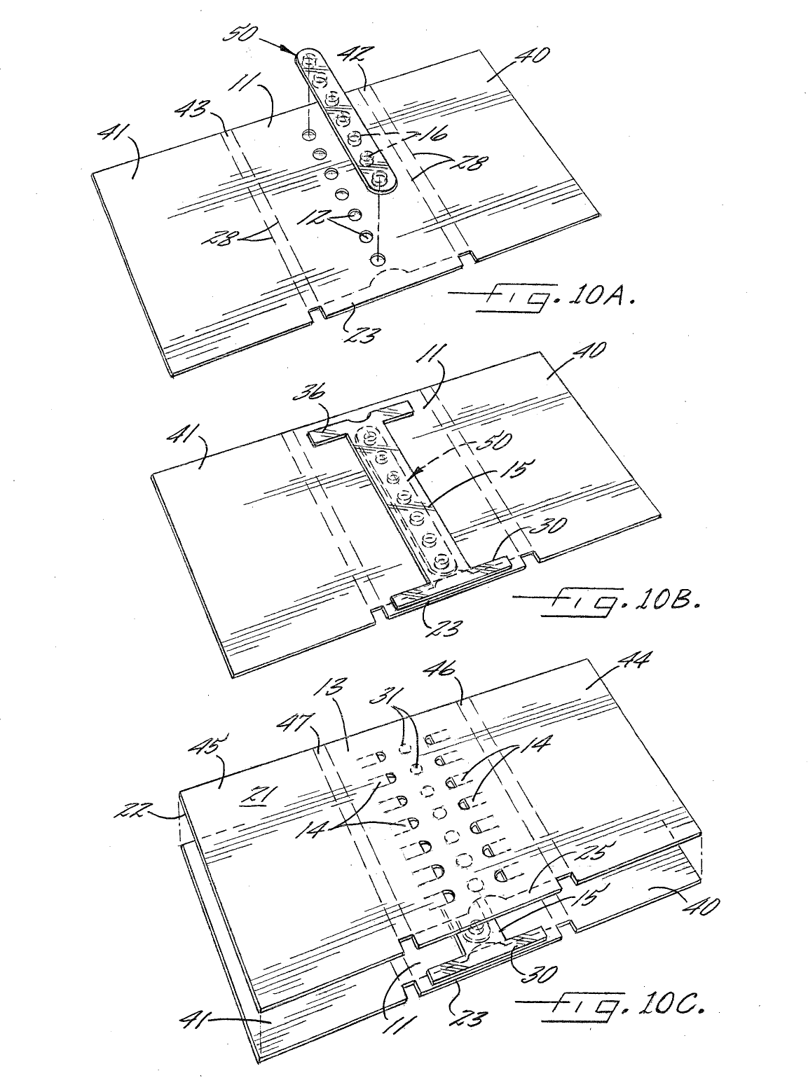

It will be further understood that the dimensions, or measurements for containers will be typically be expressed in the order of length (L), width (W), and depth (D), wherein L is typically the larger dimension at an open end of the container, W is usually the smaller dimension at an open end of the container, and D is the distance between the open ends of the container (e.g., L×W×D). With reference to the orientation of the top and bottom panels in FIGS. 7 and 8, it will be understood that the term “width” refers to a distance measured from the leftmost portion of the side panel, top panel, or bottom panel to the rightmost portion of the side panel, top panel, or bottom panel.

Further, it will also be understood that as used herein, the concept of a panel being “between” two other panels does not necessarily imply that the three panels or flaps are contiguous (i.e., in intimate contact). Rather, as used herein, the concept of one panel being between two other panels is meant to describe the relative positions of the panels within the blank structure, respectively.

Similarly, the concept of a first panel being connected to a second panel by a third panel, “opposite” the second panel, merely describes the relative positions of the first and second panels within the blank structure. It will further be understood that the term “finished” means coated with a material to produce an attractive glossy finish. The term “finished” will also be understood to mean the inclusion of printed material or other identifying indicia (e.g., a company's logo).

It will be understood that the term “score” refers to a crease along which the adjacent elements of the blank are folded without cracking or breaking to form a sleeve or container. It will be understood by those skilled in the art that the term “cut-score” refers to an impression formed by a cutting tool (e.g., a punch, die, or blade) that extends partially through a sheet of paperboard or the like. It will be understood that the term “perforations” refers to a series of holes or impressions formed by a cutting tool (e.g., a punch or die) that permits easy separation of, for example, panels. The term “perforated cut-out” refers to an impression formed in the blank that, upon removal, forms an opening.

It will be further understood that the term “fold line” or “score line” refers to a crease along which the adjacent elements of a blank are folded without cracking or breaking to form a container. It will also be appreciated that the term “glue release section” refers to a portion of, for example, a first panel to which an adhesive is applied such that a second panel can be secured against the panel having the glue release section and bearing the adhesive. The term “secured” may refer to adhered with adhesive (e.g., glue) or bonded with heat.

It will also be understood that the term “substantially rectangular” is meant to succinctly describe a simple geometric shape approximating a rectangle. Similarly, the term “substantially parallel” is meant to describe the spatial relationship between, for example, one panel to another panel, wherein the relationship is approximately parallel.

It will also be appreciated that the term “adjacent” refers to two or more, for example, panels that have a common border or are in close proximity to one another. Nevertheless, it will be understood that adjacent may or may not imply contact, but always implies the absence of anything of the same kind in between. Furthermore, as used herein, it will be understood that the term “article” will refer primarily to consumer products that are packaged for shipment (e.g., pharmaceuticals, consumables, etc.). It will be understood, however, that “article” may also refer to any number of goods such as individually packaged consumables for humans and animals, as well as individually packaged non-consumables. “Flexography” refers to a process of rotary letterpress printing using flexible plates and fast drying inks.

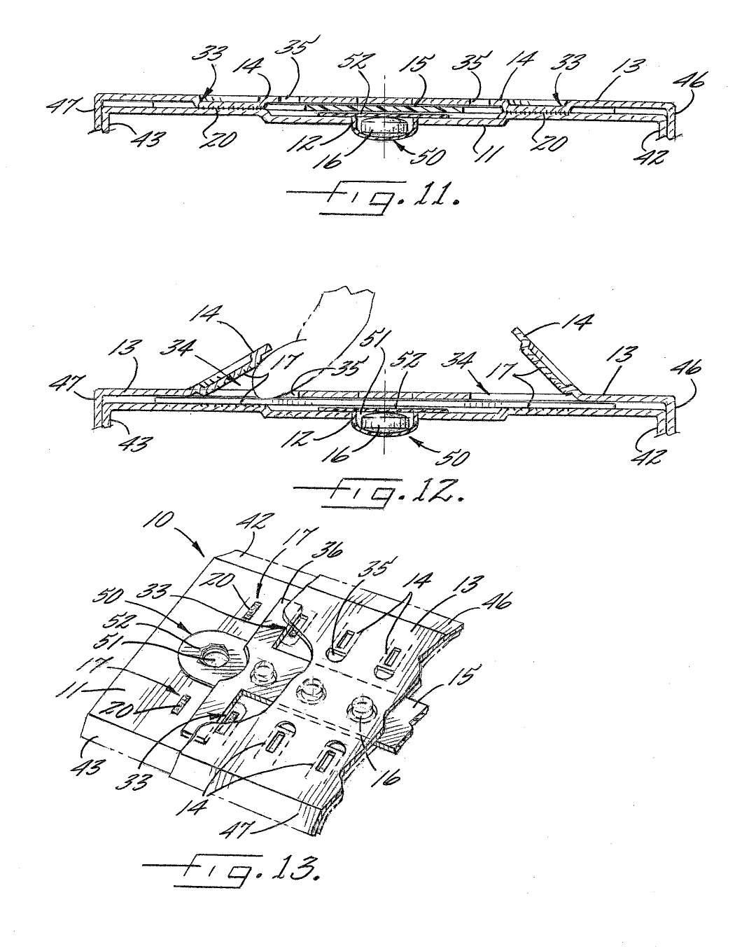

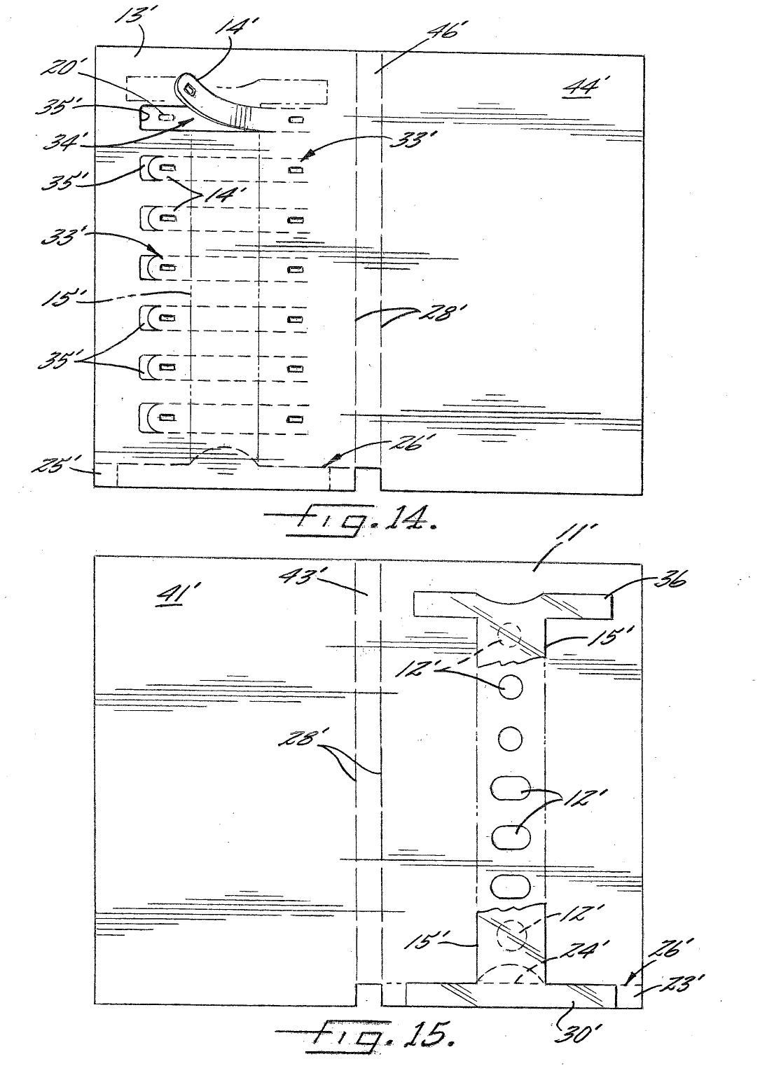

An overall view of an embodiment of a dispensing container of the invention is set forth at 10 in the perspective view of FIG. 1. As depicted in FIGS. 1 and 2, the dispensing container 10 includes a substantially rectangular bottom panel 11 defining at least one opening 12, a substantially rectangular top panel 13 secured to the bottom panel 11, at least one perforated access tab 14 defined by the top panel 13 and releasably secured to the bottom panel 11, and at least one security member 15 positioned between the bottom panel 11 and the top panel 13. In particular, a portion of the perforated access tab 14 is releasably secured to the bottom panel 11 with, for example, an adhesive 20 (see FIGS. 11 and 13). As illustrated in FIG. 1, the top panel 13 may include a plurality of perforated access tabs 14. Referring to FIG. 10C, the dispensing container 10 has an external planar side 21 and an internal planar side 22 wherein one or more sides may be finished. As depicted in FIG. 2, the bottom panel 11, top panel 13, and security member 15 form substantially parallel planes.

In a novel aspect of the invention illustrated in FIGS. 3 and 5, the security member 15 is configured to prevent and permit the dispensing of articles 16 contained within the container 10 through an opening 32 in the top panel 13.

Referring to FIG. 15, it will be understood that one embodiment of the bottom panel 11′ may include a plurality of openings 12′ having a variety of sizes depending upon the size and shape of the articles 16 to be dispensed. With reference to FIG. 8, one embodiment of the bottom panel 11 defines a tear piece 23 at one end of the dispensing container 10. The tear piece 23 may be formed by perforations 24 extending along a free edge of the bottom panel 11 such that removal of the bottom panel tear piece 23 permits access to an end of the security member 15.

With reference to FIG. 7 the top panel 13 also defines a tear piece 25 at one end of the dispensing container 10. The top panel tear piece 25 is formed by perforations 24 extending along a free edge of the top panel 13. Removal of the top panel tear piece 25 permits access to an end of the security member 15.

As illustrated in FIG. 3, the bottom and top panels 11, 13 define a tear flap 26 positioned at one end of the dispensing container 10. The tear flap 26 may be formed by perforations 24 extending along free edges of the bottom and top panels 11, 13 such that removal of the tear flap 26 permits access to an end of the security member 15. Stated differently, perforations 24 extending along free edges of the bottom and top panels 11, 13 define the tear flap 26 at one end of the dispensing container 10. As illustrated in FIG. 3, removal of the tear flap 26 permits a user to grab an end of the security member 15 in preparation for the dispensing of articles 16 from the container 10.

As depicted in FIG. 9, the security member 15 may also define a tear piece 30 at one end thereof. Perforations 24 extending along a free edge of the security member 15 define the tear piece 30. The security member tear piece 30 is positioned substantially adjacent to the tear flap 26 of the bottom and top panels 11, 13. In particular, the security member tear piece 30 is secured between the bottom panel tear piece 23 and the top panel tear piece 25 forming the tear flap 26 (see FIG. 10C). As configured, and referring to FIG. 3, removal of the tear flap 26 separates the security member tear piece 30 from the security member 15 and permits ready access to an end of the security member 15.

With general reference to FIG. 7, the top panel 13 of the dispensing container 10 may also define at least one perforated cut-out 31 that is correspondingly aligned with at least one opening 12 in the bottom panel 11. As configured, the perforated cut-out 31 facilitates the dispensing of articles 16. For example, in one embodiment, articles 16 may be dispensed through an opening 32 formed in the top panel 13 upon release or removal of the perforated cut-out 31 as represented in FIG. 5.

At least a portion of the perforated access tab 14 is releasably secured to the bottom panel 11 with, for example, an adhesive 20. As illustrated in FIGS. 11 and 13, the portion of the perforated access tab 14 that is releasably secured to the bottom panel 11 defines a stop 33. Referring to FIG. 5, the stop 33 prevents movement of the security member 15 beyond the perforated access tab 14 and the opening 12 in the bottom panel 11. The stop 33 is formed by adhesive 20 that secures a portion of the perforated access tab 14 to the bottom panel 11. FIG. 13 illustrates remains of the adhesive 20 upon release of the perforated access tab 14. Specifically, a portion of the perforated access tab 14 is adhered to a portion of the bottom panel 11 with adhesive 20 at a glue release section 17 as depicted in FIGS. 11-13. The perforated access tab 14 may be heat sealed with glue to the bottom panel 11.

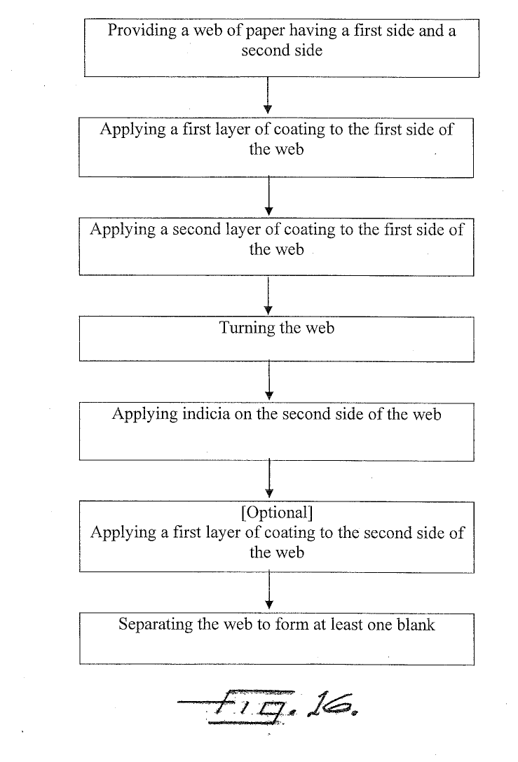

The perforated access tab 14 may be positioned substantially adjacent to the perforated cut-out 31. The perforated access tab 14 is further positioned substantially adjacent to the opening 12 in the bottom panel 11. The perforated access tab 14 extends along at least a portion of the width of the top panel 13 as illustrated in FIGS. 7 and 14. In one embodiment depicted in FIG. 7, opposing pairs of perforated access tabs 14 extend along a portion of the width of the top panel 13. In another embodiment depicted in FIG. 14, one or more perforated access tabs 14′ extend along a major portion of the width of the top panel 13′. As discussed herein, the embodiment of the top panel 13′ depicted in FIG. 14 does not provide perforated cut-outs 31 and relies upon an opening 34 formed by release of the perforated access tab 14′, wherein the opening permits the dispensing of articles 16.

As illustrated in FIGS. 5 and 13, the security member 15 is laterally moveable upon release of, for example, two perforated access tabs 14 from the bottom panel 11. Upon release of the perforated access tabs 14, the security member 15 is moveable to permit the dispensing of articles 16 from the container 10.

The top panel 13 may also provide access slots 35 formed substantially adjacent to the perforated access tabs 14. The access slots 35 facilitate removal of at least a portion of the access tabs 14 as illustrated in FIG. 12.

Referring to FIG. 9, the security member 15 includes at least one foot 36 that extends laterally from the security member 15. In one embodiment, the foot 36 extends laterally from an end of the security member 15. It will be understood that the security member 15 may be substantially L-shaped, substantially T-shaped, or substantially I-shaped. The particular shape of the security member 15 is dependent upon the number and positioning of the perforated access tabs 14 on the container 10. Specifically, the foot 36 contacts the stop 33 to prevent the dispensing of articles 16 from an opening in the container 10. In an embodiment including two pairs of opposing perforated access tabs 14 (see FIG. 7), the security member 15 is preferably T-shaped. In an embodiment including one row of perforated access tabs 14′ positioned, for example, at one edge of the top panel 13′ (see FIG. 14), the security member 15 may be L-shaped.

The dispensing container 10 may also provide any number of cover panels 40, 41, 44, 45, 41′, 44′ connected to the bottom or top panels 11, 11′, 13, 13′ as depicted in FIGS. 7, 8, 14, and 15. Referring to FIG. 8, a cover panel 40 is flexibly connected along fold lines 28 to the bottom panel 11 by a side panel 42. In this embodiment, the cover panel 40 is foldable over the bottom and top panels 11, 13 to provide additional protection of articles 16 contained therein or to provide additional surface area for indicia. Another cover panel 44 may be flexibly connected along fold lines 28 to the top panel 13 by another side panel 46, such that the cover panel is foldable over the bottom and top panels 11, 13.

In yet another embodiment illustrated in FIGS. 7 and 8, the container 10 may include a cover panel 41 flexibly connected to the bottom panel 11 by a side panel 43, and another cover panel 45 flexibly connected to the top panel 13 by another side panel 47. In one configuration, the cover panel 41 connected to the bottom panel 11 and the cover panel 45 connected to the top panel 13 are secured to one another and foldable over the bottom and top panels 11, 13. In another configuration, the cover panel 41 connected to the bottom panel 11 and the cover panel 45 connected to the top panel 13 are secured to one another and foldable against the bottom panel 11 or the top panel 13. In yet another embodiment depicted in FIG. 10C, the cover panel 40 that is connected to the bottom panel 11 and the cover panel 45 that is connected to the top panel 13 are each connected to the bottom and top panels 11, 13, respectively, opposite one another.

Referring to FIG. 2, as used in connection with the health care industry the dispensing container 10 provides a blister card 50 that is secured between the bottom panel 11 and the security member 15. In this configuration, the security member 15 prevents access to the blister card 50 and articles 16 contained therein. The blister card 50 includes at least one cavity 51 containing at least one article 16 therein (e.g., pharmaceutical). The cavity 51 is correspondingly aligned with the opening 12 in the bottom panel 11 such that the opening 12 receives a portion of the blister card 50 that defines the cavity 51. One or more membranes 52 (e.g., foil) covers the cavity 51 as illustrated in FIG. 13. The membrane provides additional protection to the pharmaceutical contained therein prior to dispensing. Sufficient pressure applied against the article 16 contained in the cavity 51 breaks the membrane 52 and permits dispensing as illustrated in FIG. 6.

In more detail with reference to the embodiment depicted in FIGS. 1 and 7-9, the container 10 includes a substantially rectangular bottom panel 11 defining at least one opening 12, a substantially rectangular top panel 13 secured to the bottom panel 11, and a security member 15 positioned between the bottom panel 11 and the top panel 13. The top panel 13 defines at least one perforated access tab 14 that is releasably secured to the bottom panel 11. The top panel 13 further defines at least one perforated cut-out 31 that is correspondingly aligned with the opening 12 in the bottom panel 11. The perforated cut-out 31 is positioned substantially adjacent to the perforated access tab 14. Advantageously, the security member 15 permits the sequential dispensing of articles 16 within the container 10 through the perforated cut-out 31 in the top panel 13.

The perforated access tab 14 prevents movement of the security member 15. The release of at least one perforated access tab 14 from the bottom panel 11 permits advancement of the security member 15 within the container 10 and provides communication between the interior of the container 10 and a perforated cut-out 31 in the top panel 13.

As depicted in FIGS. 1, 5, and 6, release of the perforated access tab 14 at one end of the container 10 from the bottom panel 11 permits lateral movement of the security member 15. Movement of the security member 15 beyond the released access tab 14, the opening 12, and the perforated cut-out 31 permits a force acting on the opening 12 in the bottom panel 11 to advance an article 16 within the container 10 through a perforated cut-out 31 in the top panel 13. As shown in FIGS. 6 and 13, force applied by a finger through an opening 12 in the bottom panel 11 and against an article 16 breaks the foil membrane 52 and separates a portion of the perforated cut-out 31 to permit dispensing.

The top panel 13 of the embodiment depicted in FIG. 7 includes at least one access slot 35 that is formed substantially adjacent to a perforated access tab 14. The access slot 35 facilitates removal of at least a portion of the perforated access tab 14 as shown in FIG. 12.

The bottom and top panels 11, 13 of the embodiment illustrated in FIGS. 7 and 8 further define a tear flap 26 at one end of the dispensing container 10. The tear flap 26 is formed by perforations 24 extending along free edges of the bottom and top panels. Referring to FIG. 3, removal of the tear flap 26 permits access to an end of the security member 15.

With specific reference to the embodiment shown in FIG. 7, the top panel 13 includes a plurality of perforated cut-outs 31 extending along at least a portion of the length of the top panel 13. This embodiment of the top panel 13 may include a plurality of perforated access tabs 14 extending along at least a portion of the length of the top panel 13 at, for example, one side of the perforated cut-outs 31. Accordingly, release of one of the perforated access tabs 14 from the bottom panel 11 permits advancement of the security member 15 to another adjacent perforated access tab 14 that remains releasably secured to the bottom panel 11. Advancement of the security member 15 provides access to the interior of the container 10 such that an article 16 may pass through the perforated cut-out 31 that is positioned substantially adjacent to the released perforated access tab 14.

More specifically, the embodiment of the top panel 13 of FIG. 7, includes a plurality of perforated cut-outs 31 and a plurality of pairs of perforated access tabs 14. The cut-outs 31 extend along a portion of the length of the top panel 13. The pairs of perforated access tabs 14 extend along a portion of the length of the top panel 13 at opposing sides of the perforated cut-outs 31. In this embodiment, release of one pair of perforated access tabs 14 from the bottom panel 11 permits advancement of the security member 15 to another adjacent pair of perforated access tabs that remain releasably secured to the bottom panel 11. Upon release of the access tab 14 and movement of the security member 15, an article 16 within the dispensing container 10 may pass through one of the perforated cut-outs 31 positioned substantially adjacent to the released pair of perforated access tabs.

Stated differently, the security member 15 in a first position prevents the dispensing of articles 16 within the container 10 through the perforated cut-outs 31 (see FIG. 1). In a second position, the security member 15 permits the dispensing of an article 16 within the container 10 through one of the perforated cut-outs 31, yet prevents the dispensing of articles 16 through other perforated cut-outs 31 (see FIG. 5).

The container 10 of the embodiment depicted in FIGS. 7-9 may include at least one cover panel 40, 41, 44, 45 flexibly connected along fold lines 28 to the bottom and top panels 11, 13 by at least one side panel 42, 43, 46, 47, wherein the cover panel is foldable over the bottom and top panels. Specifically referring to the embodiment depicted in FIGS. 10A-10C, the container 10 includes a first cover panel 40, 44 flexibly connected along fold lines 28 to the bottom and top panels 11, 13 by a first side panel 42, 46, and a second cover panel 41, 45 flexibly connected along fold lines 28 to the bottom and top panels 11, 13 by a second side panel 43, 47 opposite the first cover panel. In other words, the second cover panel 41, 45 is connected to the bottom and top panels 11, 13 opposite the side to which the first cover panel 40, 44 is connected. As configured, the first and second cover panels 40, 44, 41, 45 are foldable over the top and bottom panels 13, 11.

In more detail with reference to the embodiment depicted in FIGS. 14 and 15, the container provides a substantially rectangular bottom panel 11′ defining at least one opening 12′, a substantially rectangular top panel 13′ secured to the bottom panel 11′, and a security member 15′ positioned between the bottom panel 11′ and top panel 13′. The top panel 13′ of this embodiment defines at least one perforated access tab 14′ that is releasably secured to the bottom panel 11′. The perforated access tab 14′ is correspondingly aligned with the opening 12′ in the bottom panel 11′ such that a force acting through the opening (e.g., a finger) and applied against a blister card 50 will dispense an article 16 through an opening 34 formed by release of the perforated access tab 14′ from the bottom panel 11′. As discussed, the perforated access tab 14′ prevents movement of the security member 15′ such that release of at least one perforated access tab 14′ from the bottom panel 11′ by a user permits movement of the security member 15′. Subsequent movement of the security member 15′ permits communication between the interior of the container 10 and at least one perforated access tab 14′. In this embodiment, the security member 15′ provides for the sequential dispensing of articles 16 within the container 10 through an opening 34 formed upon release of the perforated access tab 14′ in the top panel 13′.

The embodiment of FIGS. 14 and 15 also provides at least one stop 33′ that is defined by a portion of a perforated access tab 14′ that is releasably secured to the bottom panel 11′. The stop 33′ prevents movement of the security member 15′ beyond one perforated access tab 14′ and opening 12′. The release of the perforated access tab 14′ from the bottom panel 11′ and the lateral movement of the security member 15′ beyond the released perforated access tab 14′, and beyond the opening 12′ positioned substantially opposite the released perforated access tab, permits a force acting through the opening 12′ in the bottom panel 11′ to advance at least one article 16 through the released perforated access tab 14′ in the top panel 13′.

The top panel 13′ of the embodiment illustrated in FIG. 14 may include at least one access slot 35′ formed substantially adjacent to the perforated access tab 14′. The access slot 35′ facilitates removal of at least a portion of the perforated access tab 14′. A tear flap 26′ is also provided at one end of the dispensing container 10. The tear flap 26′ is defined by the bottom and top panels 11′, 13′, and specifically, by perforations 24 extending along free edges of the bottom and top panels such that removal of the tear flap 26′ permits access to an end of the security member 15′.

Specifically referring to FIG. 14, the top panel 13′ of this embodiment includes a plurality of perforated access tabs 14′ extending along at least a portion of the length of the top panel 13′. Referring to FIGS. 12 and 14, release of one of the perforated access tabs 14′ from the bottom panel 11′ permits advancement of the security member 15′ to another perforated access tab 14′ that remains releasably secured to the bottom panel 11′ such that an article 16 within the container 10 may pass through the opening 34 formed by the released perforated access tab 14′.

In this embodiment, the security member 15′ in a first position prevents the dispensing of an article 16 within the container 10 through a perforated access tab 14′. In comparison, the security member 15′ in a second position permits the dispensing of at least one article 16 through one of the perforated access tabs 14′, yet prevents the dispensing of other articles 16 through other perforated access tabs 14′.

At least one cover panel 41′, 44′ is provided in the embodiment illustrated in FIG. 14 and 15, wherein the cover panel 41′, 44′ is flexibly connected along fold lines 28 to the bottom and top panels 11′, 13′ by at least one side panel 43′, 46′. The cover panel 41′, 44′ is foldable over the bottom and top panels 11′, 13′. It will be understood that this embodiment may include a first cover panel 41′ and a second cover panel 44′. The first cover panel 41′ is flexibly connected along fold lines 28 to the bottom and top panels 11′, 13′ by a first side panel 43′, and the second cover panel 44′ is flexibly connected along fold lines 28 to the bottom and top panels 11′, 13′ by a second side panel 46′ positioned opposite the first cover panel 41′. The first and second cover panels 41′, 44′ are foldable over the top and bottom panels.

As referenced above with respect to other embodiments of the container 10, this particular embodiment may likewise include a blister card 50 secured between the bottom panel 11′ and the security member 15′. The blister card 50 may have at least one cavity 51 containing at least one article 16. The cavity 51 is preferably aligned with at least one opening 12′ in the bottom panel 11′.

In use, an individual removes the tear flap 26 from one end of the container 10 to expose one an end of the security member 15 (see FIG. 3), and places a finger in the access slot 35 to release the perforated access tab 14 from the bottom panel 11 and to remove the stop 33 preventing movement of the security member 15 (see FIG. 12). Next the individual grasps the exposed end of the security member 15 and pulls the security member beyond the released access tab 14 and the opening 12 in the bottom panel 11 to another stop 33 formed by adjacent access tabs 14 (see FIG. 5). Thereafter, the individual places a finger in the opening 12 in the bottom panel 11 to apply a force against the cavity 51 in the blister card 50 containing the pharmaceutical, and dispenses the pharmaceutical (see FIG. 6). Upon dispensing of the initial dosage, the security member 15 is positioned at an adjacent stop 33 to prevent dispensing of another pharmaceutical until the prescribed time. Alternatively, the individual may position the security member 15 at its original starting position wherein one end is substantially adjacent to the ends of the container 10. Subsequent dispensing is achieved by the sequential release of the perforated access tabs 14 to remove the corresponding stops 33 and permit the advancement of the security member 15 beyond the next opening 12 in the bottom panel 11. As shown in FIG. 13, the novel features of the present invention permit the sequential dispensing of, for example, pharmaceuticals, in accordance with compliance requirements.

Referring to FIG. 16, it will be further understood that the invention comprises the method of manufacturing one or more packaging blanks capable of forming a container having indicia and compliance features. The method comprises the steps of providing a web (e.g., roll) of paper having a first and second side, applying a first and second layer of coating to the first side of the web, turning the web, applying indicia on the second side of the web, and separating web to form at least one blank. Optionally, the method may include applying a first layer of coating to the second side of the web.

In one embodiment, the method provides for the in-line processing of blanks used to form pharmaceutical packaging. In particular, one or more sides of the web (or substrate) is coated with a blister coating, instructions or graphics (i.e., indicia) are printed via flexography on one or more sides of the web, and the web is die-cut to form blanks capable of forming pharmaceutical packaging. In one embodiment, the method is accomplished by advancing the web along a transport path to a series of work stations. Advantageously, the present method is an in-line process incorporating the coating, printing, and die-cutting steps that typically are accomplished off-line and oftentimes at geographically separate locations. Thus, the inventive method reduces production costs and production time.

Known methods of manufacturing pharmaceutical packaging require a manufacture to purchase sheets of paper—as opposed to rolls of paper—from a supplier that have been pre-coated with, for example, blister coating of the type used in pharmaceutical packaging. These pre-coated sheets of paper are more expensive than rolls of paper lacking the blister coating. The supplier produces these pre-coated sheets by applying various layers of coating to a web and then separating the web into sheets according to the manufacturer's requests. The suppliers of the pre-coated sheets require relatively long lead times to produce the pre-coated sheets according to the manufacturer's specification. Upon production, the pre-coated sheets must be transported and delivered to the manufacturer. The long lead times from ordering to delivery make it difficult for the manufacture to efficiently order and stock the pre-coated sheets.

Further aggravating efficiencies, the pre-coated sheets have a limited shelf time (i.e., approximately six months). Thus, prior to ordering from the supplier, a manufacture must estimate its requirement for current and future orders of the pre-coated sheets. Estimated requirements often lead to overstock or lack of stock. A failure to use all pre-coated sheet stock on hand results in waste if the shelf-life has expired and the manufacturer is forced to dispose of the pre-coated sheet stock.

Moreover, known methods typically accomplish the steps of coating, printing, and die-cutting at geographically separate locations. Stated differently, known methods do not provide an in-line continuous process for the coating, printing, and die-cutting of pharmaceutical packaging at one geographic location. The present method addresses inefficiencies in the known methods.

The step of providing a web may include providing a roll of paper or paperboard material having a first and second side. Upon the step of providing, the web is advanced to a first coating station where a first layer of coating is applied to the first side of the web. This first layer of coating serves as a primer. This coating may be any number of types of waterborne polyurethane blister board coating designed for in-line coating over wet ink or off-line coating over dry ink.

Next, a second layer of the coating is applied to the first side of the web over the first layer of coating. The combination of the two layers of coating serves as a heat seal or blister coating.

As a next step, the web advances to a verification station where the web is inspected to ensure that the amount of blister coating applied to the web exceeds a predetermined standard. In one embodiment, the inspection step determines whether the coated web is of a desirable minimum weight to ensure that a sufficient amount of coating (formed of the first and second layers) is present to form a proper bond between the coating and web when heat and pressure are applied at the final operation of packaging, for example, pharmaceuticals or pills. It will be understood that webs of this type are measured in pounds per thousand square feet.

It will be understood that the method of inspecting may include a weight measurement of the coated web, a thickness measurement of the coating on the web, or any number of methods for ensuring that the amount of coating present on the web is sufficient to meet a desirable standard for proper sealing performance on a pharmaceutical (or pill) packaging line. A proper seal on the pharmaceutical packaging line is necessary to ensure that a pharmaceutical package design meets its functional requirement to prevent children from obtaining ready access to an article (e.g., pharmaceutical) in the container, while permitting access to an article by a senior patient.

During the inspection, at least a portion of the width of the coated web is inspected using, for example, a scale, a scanner capable of measuring the thickness of the coatings and/or web, or any number of devices capable of measuring the weight of the coating or the thickness of the layer of coatings and/or web. It will be understood that the goal of the inspection is to ensure that a sufficient amount of coating has been applied to the web to ensure a secure heat seal.

Upon satisfying a desired measurement, the web advances to the next station. Alternatively, an indicator will inform the user that the web does not meet a desirable measurement. When sub-standard portions of the web are identified, advancement of the web may be stopped and the sub-standard portions are removed before advancement to a die-cutting operation.

The web coated on one side is then advanced to a turning station where the web is turned or flipped over by a turning arm. The turned web is then advanced to a printing station where indicia in the form of printed instructions or graphics are applied to the second side of the web opposite the first side bearing the first and second layers of coating.

In an optional step, the web is advanced to another coating station where a first layer of coating is applied to the second side of the web containing the indicia (i.e., opposite the side of the web having the first and second layers of coating). This first layer of coating is applied to the second side of the web as a protective layer over the indicia. This first layer of coating on the second side may include any number of aqueous-based or ultraviolet (UV) coatings.

In the final steps of the method, the web is advanced along the transport path to a separating station where the web is die-cut into any number of blanks. Upon die-cutting the web into blanks, the blanks are ready for transport to a pharmaceutical manufacturer for construction of the packaging or container. In one example, the blanks are transported to a pharmaceutical manufacture where two blanks are formed into a single container and a blister card containing pharmaceuticals is incorporated therein.

This novel method further provides for the manufacture of small dimension packaging requiring blanks smaller than 20″×26″ in small to medium run sizes generally ranging from 1000 to 1,000,000 blanks. The present method also increases storage efficiencies by permitting the manufacturer to produce a die-cut blank of specific dimensions directly from a web as opposed to storing large quantities of pre-coated sheets having limited shelf life. It will be understood that this method provides for packaging used in healthcare, pharmaceuticals, cosmetics, consumer goods (e.g., small boxes) and promotional cartons.

In the drawings and specification, there have been disclosed typical embodiments on the invention and, although specific terms have been employed, they have been used in a generic and descriptive sense only and not for purposes of limitation, the scope of the invention being set forth in the following claims.

That which is claimed is:

1. A container for dispensing articles comprising:
a substantially rectangular bottom panel defining at least one opening;
a substantially rectangular top panel secured to said bottom panel, said top panel defining at least one perforated access tab releasably secured to said bottom panel; and
at least one security member positioned between said bottom panel and said top panel, said security member for preventing and permitting the dispensing of articles from said container;
wherein said security member is moveable upon release of said at least one perforated access tab from said bottom panel to permit the dispensing of at least one article from said container.

2. A dispensing container according to claim 1 wherein:
said bottom and top panels further defining a tear flap at one end of said container, said tear flap formed by perforations extending along edges of said bottom and top panels; and
removal of said tear flap permits access to an end of said security member.

3. A dispensing container according to claim 1 wherein said top panel includes at least one access slot formed substantially adjacent to said at least one perforated access tab to facilitate removal of at least a portion of said access tab.

4. A dispensing container according to claim 1 wherein said top panel further defining at least one perforated cut-out correspondingly aligned with said at least one opening in said bottom panel, said at least one perforated cut-out facilitating the dispensing of articles from said container.

5. A dispensing container according to claim 4 wherein said at least one perforated cut-out is positioned substantially adjacent to said at least one perforated access tab in said top panel.

6. A dispensing container according to claim 1 wherein said at least one perforated access tab is positioned substantially adjacent to said at least one opening in said bottom panel.

7. A dispensing container according to claim 1 wherein said security member includes at least one foot that extends laterally therefrom.

8. A dispensing container according to claim 1 further comprising a blister card secured between said bottom panel and said security member, said blister card having at least one cavity containing at least one article therein, said at least one cavity correspondingly aligned with said at least one opening in said bottom panel.

9. A container for dispensing articles comprising:
a substantially rectangular bottom panel defining at least one opening;
a substantially rectangular top panel secured to said bottom panel, said top panel defining at least one perforated access tab releasably secured to said bottom panel, said top panel further defining at least one perforated cut-out correspondingly aligned with said at least one opening in said bottom panel, said at least one perforated cut-out substantially adjacent to said at least one perforated access tab; and
a security member positioned between said bottom panel and said top panel, said security member for sequentially dispensing articles contained within said container through said at least one perforated cut-out in said top panel;
wherein said at least one perforated access tab prevents movement of said security member such that release of said at least one perforated access tab from said bottom panel facilitates movement of said security member and permits communication between an interior of said container and said at least one perforated cut-out in said top panel.

10. A dispensing container according to claim 9 wherein a portion of said at least one perforated access tab releasably secured to said bottom panel defines a stop, said stop preventing movement of said security member beyond said at least one perforated access tab and said at least one opening.

11. A dispensing container according to claim 9 wherein release of said at least one perforated access tab at one end of said container from said bottom panel and movement of said security member beyond said released perforated access tab and said at least one opening permits advancement of at least one article within said container through said at least one perforated cut-out in said top panel.

12. A dispensing container according to claim 9 wherein:
said bottom and top panels further defining a tear flap at one end of said dispensing container, said tear flap formed by perforations extending along edges of said bottom and top panels; and
removal of said tear flap permits access to an end of said security member.

13. A dispensing container according to claim 9 wherein the release of one of said perforated access tabs from said bottom panel permits advancement of said security member to another said perforated access tab such that at least one article within said container may pass through said perforated cut-out positioned substantially adjacent to said released perforated access tab.

14. A dispensing container according to claim 9 wherein said security member in a first position prevents the dispensing of at least one article within said container through said at least one perforated cut-out.

15. A dispensing container according to claim 9 wherein said security member in a second position permits the dispensing of at least one article within said container through one of said at least one perforated cut-outs, yet prevents the dispensing of at least another article through another of said at least one perforated cut-outs.

16. A dispensing container according to claim 9 further comprising a blister card secured between said bottom panel and said security member, said blister card having at least one cavity containing at least one article therein, said at least one cavity correspondingly aligned with said at least one opening in said bottom panel.

17. A container for dispensing articles comprising:
a substantially rectangular bottom panel defining at least one opening;
a substantially rectangular top panel secured to said bottom panel, said top panel defining at least one perforated access tab releasably secured to said bottom panel, said at least one perforated access tab correspondingly aligned with said at least one opening in said bottom panel; and
a security member positioned between said bottom panel and said top panel, said security member for sequentially dispensing articles within said container through said at least one perforated access tab in said top panel;
wherein said at least one perforated access tab prevents movement of said security member such that release of said at least one perforated access tab from said bottom panel facilitates movement of said security member and permits communication between an interior of said container and said at least one perforated access tab in said top panel to dispense the articles.

18. A dispensing container according to claim 17 wherein a portion of said at least one perforated access tab releasably secured to said bottom panel defines a stop, said stop preventing movement of said security member beyond said at least one perforated access tab and said at least one opening.

19. A dispensing container according to claim 17 wherein the release of one of said perforated access tabs from said bottom panel permits advancement of said security member to another said perforated access tab such that at least one article within said container may pass through said released perforated access tab.

20. A dispensing container according to claim 17 wherein said security member in a first position prevents the dispensing of at least one article within said container through said at least one perforated access tab.

21. A dispensing container according to claim 17 wherein said security member in a second position permits the dispensing of at least one article within said container through one of said at least one perforated access tabs, yet prevents the dispensing of at least another article through another of said at least one perforated access tabs.

22. A dispensing container according to claim 17 further comprising a blister card secured between said bottom panel and said security member, said blister card having at least one cavity containing at least one article therein, said at least one cavity correspondingly aligned with said at least one opening in said bottom panel.

23. A method of manufacturing a packaging blank capable of forming a container having indicia and compliance features, said method comprising the steps of:
providing a web of paper having a first side and a second side;
applying a first layer of coating to the first side of the web;
applying a second layer of coating to the first side of the web;
verifying compliance of the web with a desired standard;
turning the web;
applying indicia on the second side; and
separating the web to form at least one blank.

24. The method according to claim 23, wherein the step of verifying comprises measuring the weight of at least a portion of the coated web.

25. The method according to claim 23, further comprising the step of applying a first layer of coating to the second side of the web performed after the step of applying indicia.
